(19) United States
(12) Patent Application Publication
(10) Pub. No.: US 2025/0095059 A1
(43) Pub. Date: Mar. 20, 2025

(54) CONTENT BUYING AND SELLING DEVICE AND CONTENT BUYING AND SELLING METHOD

(71) Applicant: JVCKENWOOD Corporation, Yokohama-shi (JP)

(72) Inventor: Akihiro KITAZAWA, Yokohama-shi (JP)

(21) Appl. No.: 18/964,004

(22) Filed: Nov. 29, 2024

Related U.S. Application Data
(63) Continuation of application No. PCT/JP2023/014971, filed on Apr. 13, 2023.

(30) Foreign Application Priority Data
Jun. 16, 2022 (JP) 2022-097028

(51) Int. Cl. G06Q 30/08; G06Q 30/0201; G06Q 50/00

(52) U.S. Cl. CPC G06Q 30/08; G06Q 30/0201; G06Q 50/01

(57) ABSTRACT

A trend determination unit determines whether the content registered in a registration unit or an item related to the content is a trend, and determines whether the content or the item related to the content has become a trend in a short period of time that is a predetermined time when determining that the content or the item related to the content is a trend. An auction process unit sets a first auction starting price when the content or the item related to the content is a trend and has not become a trend in a short period of time. An auction process unit sets a second auction starting price higher than the first auction starting price when the content or the item related to the content is a trend and has become a trend in a short period of time, and puts the content up for auction.

### CROSS-REFERENCE TO RELATED APPLICATIONS

This application is a continuation of PCT Application No. PCT/JP2023/014971, filed on Apr. 13, 2023, and claims the priority of Japanese Patent Application No. 2022-097028, filed on Jun. 16, 2022, the entire contents of both of which are incorporated herein by reference.

### BACKGROUND

The present disclosure relates to a content buying and selling device and a content buying and selling method.

As disclosed in Japanese Unexamined Patent Application Publication No. 2006-331284, online auctions for buying and selling goods by auction via a network have become popular.

### SUMMARY

Ownership of content such as audio data or video data can also be bought and sold by auction. However, simply listing the content on an auction site may not increase the desire to purchase the content, and thus no bidders will appear, making it difficult to sell the content.

A first aspect of one or more embodiments provides a content buying and selling device including: a registration unit configured to register target content whose ownership is bought and sold by auction; a database configured to store the content registered in the registration unit; a trend determination unit configured to determine whether the content registered in the registration unit or an item related to the content is a trend, and to determine whether the content or the item related to the content has become a trend in a short period of time that is a predetermined time when determining that the content or the item related to the content is a trend; and an auction process unit configured to set a first auction starting price as an auction starting price of the content when the trend determination unit has determined that the content or the item related to the content is a trend and has not become a trend in a short period of time, and to set a second auction starting price, which is higher than the first auction starting price, as an auction starting price of the content when the trend determination unit has determined that the content or the item related to the content is a trend and has become a trend in a short period of time, thereby putting the content up for auction.

A second aspect of one or more embodiments provides a content buying and selling method including: storing content that is registered in a registration unit in a database; determining, by a trend determination unit, whether the content registered in the registration unit or an item related to the content is a trend; determining, by the trend determination unit, whether the content registered in the registration unit or the item related to the content has become a trend in a short period of time that is a predetermined time when determining that the content registered in the registration unit or the item related to the content is a trend; setting, by an auction processing unit, a first auction starting price as an auction starting price of the content when the content or the item related to the content is a trend and has not become a trend in a short period of time, and putting the content up for auction; and setting, by the auction processing unit, a second auction starting price, which is higher than the first auction starting price, as an auction starting price of the content when the content or the item related to the content is a trend and has become a trend in a short period of time, and putting the content up for auction.

### BRIEF DESCRIPTION OF THE DRAWINGS

FIG. 1 is a block diagram illustrating a content buying and selling device according to one or more embodiments.

FIG. 2 is a diagram illustrating an example of a data structure of content.

FIG. 3 is a flowchart illustrating a content buying and selling method according to one or more embodiments.

### DETAILED DESCRIPTION

Hereinafter, a content buying and selling device and a content buying and selling method according to one or more embodiments will be described in detail with reference to the drawings.

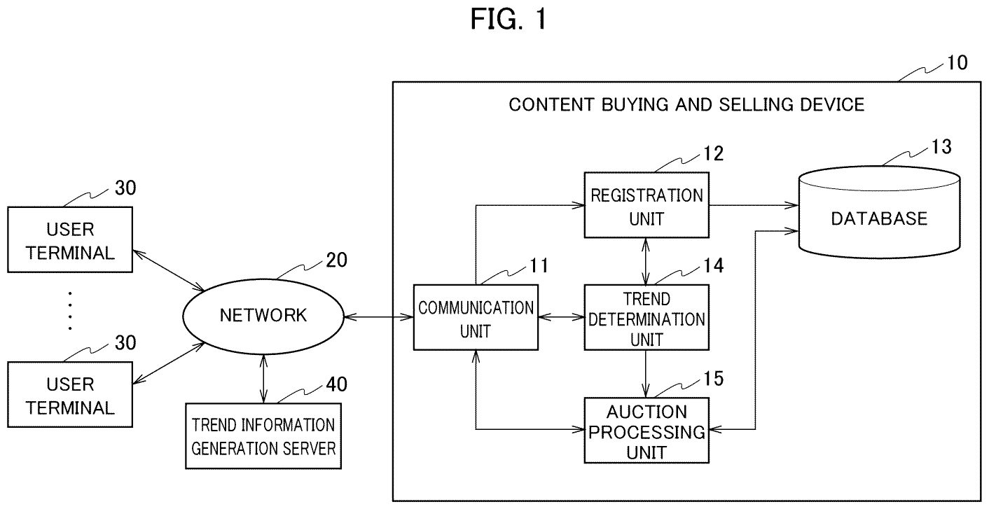

In FIG. 1, a content buying and selling device 10 and one or more user terminals 30 are connected to each other via a network 20. Typically, the network 20 is the Internet. A trend information generation server 40 is connected to the network 20. The content buying and selling device 10 can be configured by an auction server. The content buying and selling device 10 includes a communication unit 11, a registration unit 12, a database 13, a trend determination unit 14, and an auction processing unit 15.

When a user who owns a user terminal 30 intends to buy and sell the content having the ownership by auction, the user requests the registration of the content to the content buying and selling device 10 using the user terminal 30. The content is called digital content.

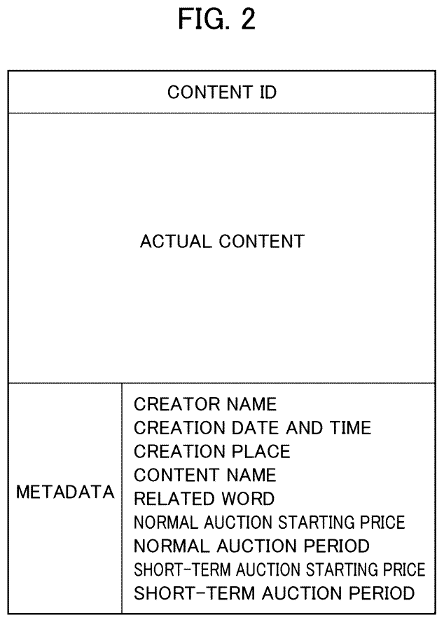

FIG. 2 illustrates an example of the data structure of the content. The content includes a content ID, actual content that is content data itself such as audio data or video data, and metadata. The metadata includes a creator name of the actual content, a creation date and time, a creation place, a content name, a related word, a normal auction starting price, a normal auction period, a short-term auction starting price, and a short-term auction period, for example.

When the normal auction starting price is a first auction starting price that is a predetermined price, the short-term auction starting price is preferably a second auction starting price higher than the first auction starting price. When the normal auction period is a first auction period that is a predetermined period, the short-term auction period is preferably a second auction period shorter than the first auction period.

The metadata includes, at least, a content name, a normal auction starting price, a normal auction period, a short-term auction starting price, and a short-term auction period. Further, the metadata preferably includes a related word. The content name is a title. The related word is a word indicating an item related to the content. For example, the related word may be a movie or a program name in which the content is used, a performer's name (especially a leading actor's name) of a movie or a program in which the content is used, a director's name of a movie in which the content is used, or a place name of a shooting place.

The user sets a normal auction starting price, a normal auction period, a short-term auction starting price, and a short-term auction period when requesting the registration of the content to the content buying and selling device 10. The increase-decrease rate may be determined such that the short-term auction starting price may be 1.5 times the normal auction starting price, and the short-term auction period may be 0.7 times the normal auction period. In this case, the user sets only the normal auction starting price and the normal auction period. Even in such a case, the user has set the short-term auction starting price and the short-term auction period.

Referring back to FIG. 1, the registration unit 12 registers the content ID of the content received by the communication unit 11 from the user terminal 30 and the metadata of the content. The database 13 stores the content. When the content is registered in the registration unit 12, the trend determination unit 14 acquires trend information from the trend information generation server 40. As an example, the trend information generation server 40 is a server that provides a service called Google Trends provided by Google LLC.

The trend information generation server 40 generates trend information according to the frequency with which various words are searched by a search engine. For example, the trend information generation server 40 generates the trend information in such a way that a relative value of the search frequency of a certain word is 100, a relative value of the search frequency of another certain word is 50, and a relative value of the search frequency of another certain word is 0. The trend information generation server 40 may generate the trend information according to the frequency actually used in the social networking service.

The trend determination unit 14 determines whether a content name of the content registered in the registration unit 12 is a trend based on the trend information generated by the trend information generation server 40. The content name is a target word to determine whether the content itself is a trend. When having determined that the content name is a trend, the trend determination unit 14 determines whether the content name has become a trend in a short period of time. The short period of time is a predetermined period such as 1 week.

The trend determination unit 14 may use a related word as a target word to determine whether the content is a trend. The trend determination unit 14 determines whether the related word of the content registered in the registration unit 12 is a trend based on the trend information generated by the trend information generation server 40. When having determined that the related word is a trend, the trend determination unit 14 determines whether the related word has become a trend in a short period of time.

Taking trend information corresponding to the frequency searched by a search engine as an example, the trend determination unit 14 determines that the related word is a trend when a relative value of the search frequency of the word of the trend information generated by the trend information generation server 40 is 70 or more, for example. At this time, when determining whether the content name is a trend, the trend determination unit 14 determines that the content name is a trend by assigning a first weighting to the relative value of the search frequency of the word of the trend information. The first weighting is 1, for example.

When determining whether the related word is a trend, the trend determination unit 14 determines that the related word is a trend by assigning a second weighting, which is smaller than the first weighting, to the relative value of the search frequency of the word of the trend information. The second weighting may be set to an appropriate value smaller than 1, such as 0.8 or 0.5. That is, in a case where the second weighting is 0.8, when determining whether the related word is a trend, the trend determination unit 14 determines that the related word is a trend if the relative value of the search frequency of the word of the trend information generated by the trend information generation server 40 is 87.5 or more.

The trend determination unit 14 determines whether the content name or the related word has become a trend in a short period of time as follows. For example, the trend determination unit 14 determines that the content name or the related word has become a trend in a short period of time if the difference between the relative value of the search frequency of the word in the most recent week and the relative value of the search frequency of the word in a week before the most recent week exceeds a threshold value. The trend determination unit 14 may determine whether the content name or the related word has become a trend in a short period of time based on the difference between the relative value of the search frequency of the word in the most recent month and the relative value of the search frequency of the word in a month before the most recent month.

When having determined that any of the contents registered in the registration unit 12, or the item related to the content is a trend, the trend determination unit 14 provides to the auction processing unit 15, a content ID of the content that is a trend and information indicating whether the content has become a trend in a short period of time.

The auction processing unit 15 sets a normal auction starting price as an auction starting price of the content to the content determined that the content itself or the item related to the content is a trend, and has not become a trend in a short period of time. At this time, the auction processing unit 15 preferably sets a normal auction period as an auction period of the content. The auction processing unit 15 puts the content up for auction at the set normal auction starting price (and the normal auction period).

The auction processing unit 15 sets a short-term auction starting price as an auction starting price of the content to the content determined that the content itself or the item related to the content is a trend, and has become a trend in a short period of time. At this time, the auction processing unit 15 preferably sets a short-term auction period as an auction period of the content. The auction processing unit 15 puts the content up for auction at the set short-term auction starting price (and the short-term auction period).

Since the content that has become a trend in a short period of time is likely to be bought and sold at a high price, it is preferable to set the short-term auction starting price, which is higher than the normal auction starting price, as the auction starting price. Also, since the content that has become a trend in a short period of time is likely to be bought and sold in a short period of time, it is preferable to set the short-term auction period, which is shorter than the normal auction period, as the auction period.

If there are bidders for the content that is put up for auction, the auction processing unit 15 sells the content to the highest bidder as a winning bidder. The auction processing unit 15 reads out the content for which a winning bid has been made from the database 13 and transmits it to the user terminal 30 owned by the winning bidder.

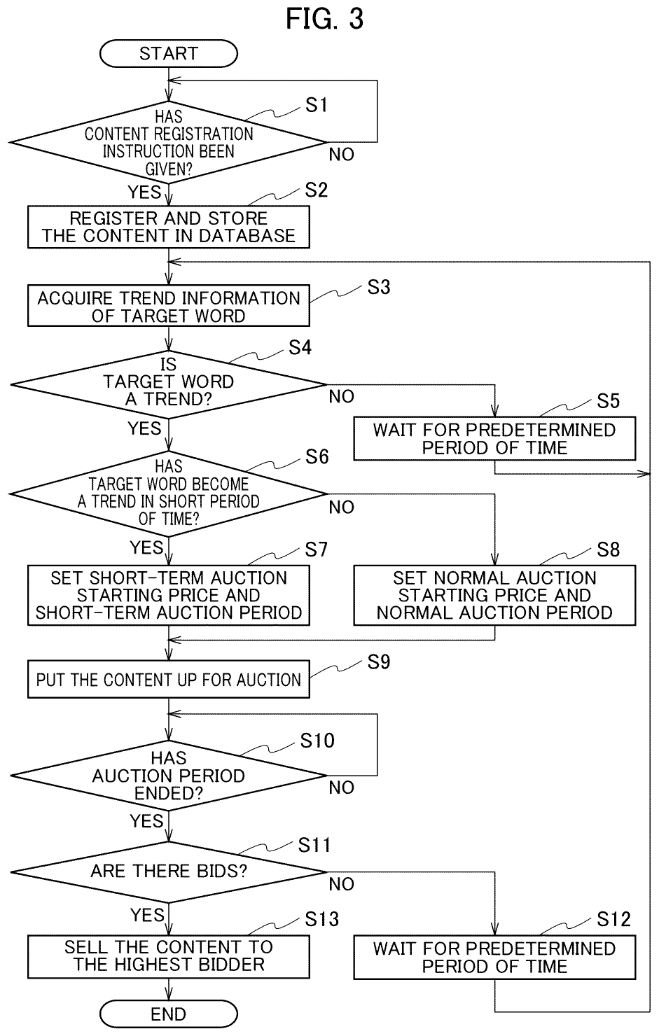

A content buying and selling method according to one or more embodiments performed by the content buying and selling device 10 will be described with reference to a flowchart illustrated in FIG. 3. Referring to FIG. 3, when the processing of the content buying and selling device 10 is started, the content buying and selling device 10 determines in step S1 whether a content registration instruction has been given. If a content registration instruction has not been given (NO), the content buying and selling device 10 repeats the processing of step S1. If a content registration instruction has been given (YES), the content buying and selling device 10 registers the content in the registration unit 12, and stores the content in the database 13 in step S2.

The content buying and selling device 10 acquires the trend information of a target word in step S3. The content buying and selling device 10 determines whether the target word is a trend in step S4. If the target word is not a trend (NO), the content buying and selling device 10 waits for a predetermined period of time in step S5 and returns the processing to step S3. The predetermined period is one day, one week, or the like. If the target word is a trend (YES), the content buying and selling device 10 determines whether the target word has become a trend in a short period of time in step S6. Steps S3 to S6 are the processing performed by the trend determination unit 14.

If the target word has become a trend in a short period of time in step S6 (YES), the content buying and selling device 10 sets a short-term auction starting price and a short-term auction period in step S7, and moves the processing to step S9. If the target word has not become a trend in a short period of time in step S6 (NO), the content buying and selling device 10 sets a normal auction starting price and a normal auction period in step S8, and moves the processing to step S9.

The content buying and selling device 10 puts the content in which the target word is a trend up for auction in step S9. The content buying and selling device 10 determines whether the auction period has ended in step S10. If the auction period has not ended (NO), the content buying and selling device 10 repeats the processing of step S10. If the auction period has ended (YES), the content buying and selling device 10 determines whether there are bids in step S11.

If there are no bids in step S11 (NO), the content buying and selling device 10 waits for a predetermined period of time in step S12 and returns the processing to step S3. The predetermined periods of step S5 and step S12 may be the same or different periods. If there are bids in step S11 (YES), the content buying and selling device 10 sells the content to the highest bidder in step S13 and ends the processing. Steps S7 to S13 are the processing performed by the auction processing unit 15.

In the content buying and selling device and the content buying and selling method according to one or more embodiments described above, since the content itself or the item related to the content is put up for auction when it is a trend, the ownership of the content can be sold more easily by auction.

The present invention is not limited to one or more embodiments described above, and various changes can be made without departing from the gist of the present invention. The content buying and selling device 10 may have a configuration corresponding to the trend information generation server 40. The related word may be grouped into a plurality of groups, and a different weighting may be assigned to each group.

The trend determination unit 14 may divide the related word into a plurality of groups, and differentiate the second weighting in each group.

What is claimed is:

1. A content buying and selling device comprising:
a registration unit configured to register target content whose ownership is bought and sold by auction;
a database configured to store the content registered in the registration unit;
a trend determination unit configured to determine whether the content registered in the registration unit or an item related to the content is a trend, and to determine whether the content or the item related to the content has become a trend in a short period of time that is a predetermined time when determining that the content or the item related to the content is a trend; and
an auction process unit configured to set a first auction starting price as an auction starting price of the content when the trend determination unit has determined that the content or the item related to the content is a trend and has not become a trend in a short period of time, and to set a second auction starting price, which is higher than the first auction starting price, as an auction starting price of the content when the trend determination unit has determined that the content or the item related to the content is a trend and has become a trend in a short period of time, thereby putting the content up for auction.

2. The content buying and selling device according to claim 1, wherein
the auction process unit is configured to set:
a first auction period as an auction period of the content when the trend determination unit has determined that the content or the item related to the content has not become a trend in a short period of time; and
a second auction period, which is shorter than the first auction period, as an auction period of the content when the trend determination unit has determined that the content or the item related to the content has become a trend in a short period of time.

3. The content buying and selling device according to claim 1, wherein
the trend determination unit is configured to determine:
whether the content is a trend by assigning a first weighting to trend information based on a frequency with which a content name of the content is searched by a search engine or to trend information based on a frequency with which the content name is used in a social networking service; and
whether the item related to the content is a trend by assigning a second weighting, which is smaller than the first weighting, to trend information based on a frequency with which a related word indicating the item related to the content is searched by the search engine or to trend information based on a frequency with which the related word is used in the social networking service.

4. The content buying and selling device according to claim 2, wherein
the trend determination unit is configured to determine:
whether the content is a trend by assigning a first weighting to trend information based on a frequency with which a content name of the content is searched by a search engine or to trend information based on a frequency with which the content name is used in a social networking service; and
whether the item related to the content is a trend by assigning a second weighting, which is smaller than the first weighting, to trend information based on a frequency with which a related word indicating the item related to the content is searched by the search engine or to trend information based on a frequency with which the related word is used in the social networking service, and
the registration unit is configured to register in the content, the first auction starting price, the second auction starting price, the first auction period, the second auction period, the content name, or the related word as metadata.

5. The content buying and selling device according to claim 3, wherein
the trend determination unit is configured to divide the related word into a plurality of groups, and differentiate the second weighting in each group.

6. A content buying and selling method comprising:
storing content that is registered in a registration unit in a database;
determining, by a trend determination unit, whether the content registered in the registration unit or an item related to the content is a trend;
determining, by the trend determination unit, whether the content registered in the registration unit or the item related to the content has become a trend in a short period of time that is a predetermined time when determining that the content registered in the registration unit or the item related to the content is a trend;
setting, by an auction processing unit, a first auction starting price as an auction starting price of the content when the content or the item related to the content is a trend and has not become a trend in a short period of time, and putting the content up for auction; and
setting, by the auction processing unit, a second auction starting price, which is higher than the first auction starting price, as an auction starting price of the content when the content or the item related to the content is a trend and has become a trend in a short period of time, and putting the content up for auction.
